(19) United States
(12) Patent Application Publication
(10) Pub. No.: US 2012/0154300 A1
(43) Pub. Date: Jun. 21, 2012

(54) SYSTEM AND METHOD FOR DATA EXCHANGE BETWEEN ELECTRONIC DEVICE AND REMOTE DISPLAY

(75) Inventor: CEN MA, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/167,740

(22) Filed: Jun. 24, 2011

(30) Foreign Application Priority Data
Dec. 20, 2010 (CN) 201010596688.6

(51) Int. Cl. G06F 3/041

(52) U.S. Cl. 345/173

(57) ABSTRACT

In a method of data exchange between an electronic device and a remote display, a touch panel of the remote display registers contact to generate coordinates transmitted to the electronic device by wireless communication. The electronic device executes applications corresponding to the coordinates, the wireless communication modules transmit images corresponding to the applications from the electronic device to the remote display.

### BACKGROUND

1. Technical Field

Embodiments of the present disclosure relate to control methods of an electronic device, and more particularly to a system and method of data transferring in an electronic device utilizing a remote display.

2. Description of Related Art

An electronic device can be used for viewing e-books, websites and document processing, such as a tablet computer or a notebook. A tablet computer can use a virtual keypad displayed on a touch panel used on the tablet computer, and a physical keyboard used on a notebook. However, the touch panel of the tablet computer is not convenient for input and the physical keyboard of the notebook is not simple and intuitive. What is needed, therefore, is a system and method overcoming the limitations described.

### BRIEF DESCRIPTION OF THE DRAWINGS

FIG. 1 is a block diagram of one embodiment of a data exchange system.

FIG. 2 is a block diagram of one embodiment of a data exchange unit as disclosed, utilizing the electronic device of FIG. 1.

FIG. 3 is a flowchart of one embodiment of a method for data exchange using an electronic system for data exchange.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

All of the processes described below may be embodied in, and fully automated via, input method modules executed by one or more general purpose processors of an electronic device. Some or all of the methods may alternatively be embodied in specialized hardware. The input method modules may be stored in any type of computer-readable medium or other computer storage device. In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives

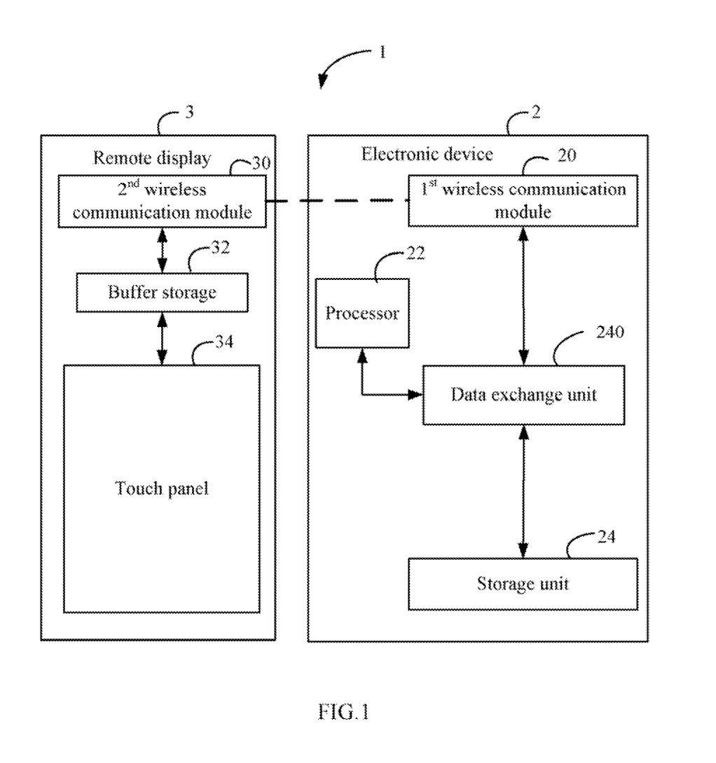

FIG. 1 is a block diagram of one embodiment of a data exchange system 1. The data exchange system 1 includes an electronic device 2 and a remote display 3. Depending on the embodiment, the electronic device 2 may be a mobile phone, a personal digital assistant (PDA), a handheld game console, a tablet computer, or other device.

The electronic device 2 is generally controlled and coordinated by an operating system software, such as UNIX, LINUX, WINDOWS, MAC OS X, an embedded operating system, or any other compatible operating systems. In other embodiments, the electronic device 2 may be controlled by a proprietary operating system. Usual operating systems control and schedule computer processes for execution, perform memory management, provide file system, networking, and I/O services, and provide a user interface, such as a graphical user interface (GUI), among other things.

The electronic device 2 includes a first wireless communication module 20, at least one processor 22, a storage unit 24 and a data exchange unit 240. The remote display 3 includes a second wireless communication module 30, a buffer storage 32 and a touch panel 34. The touch panel 34 is electrically connected to the second wireless communication module 30 and the buffer storage 32.

The electronic device 2 wirelessly connects to the remote display 3 to exchange information using the first wireless communication module 20 and the second wireless communication module 30. The touch panel of the remote display is a capacitive panel or a resistive panel. In one embodiment, the first wireless communication module 20 and the second wireless communication module 30 may be BLUETOOTH modules or infrared modules.

The remote display 3 includes the second wireless communication module 30, the buffer storage 32 and the touch panel 34. The remote display 3 is operable to display information related to the electronic device 2 and receive user input by the touch panel 34. In one embodiment, the information related to the electronic device 2 and user input can be communicated between the electronic device 2 and the remote display 3 by the first wireless communication module 20 and the second wireless communication module 30.

The touch panel 34 includes a contact region that detects a human finger or a stylus in contact with the touch panel 34 to generate coordinates corresponding to applications installed in the electronic device 2. The coordinates respectively link to applications stored in the storage unit 24. The at least one processor 22 can execute the applications according to the coordinates generated. In one embodiment, a coordinate E links to a media player for playback of video files. If the touch panel 34 detects the coordinate E generated in a user interface, the at least one processor 22 executes the media player to play video files.

The buffer storage 32 is operable to store the coordinates generated from the touch panel 34 and the images corresponding to the applications transmitted from the second wireless communication module 30. In one embodiment, the buffer storage 32 may be a hard disk drive, flash memory, RAM, ROM, cache, or external storage device.

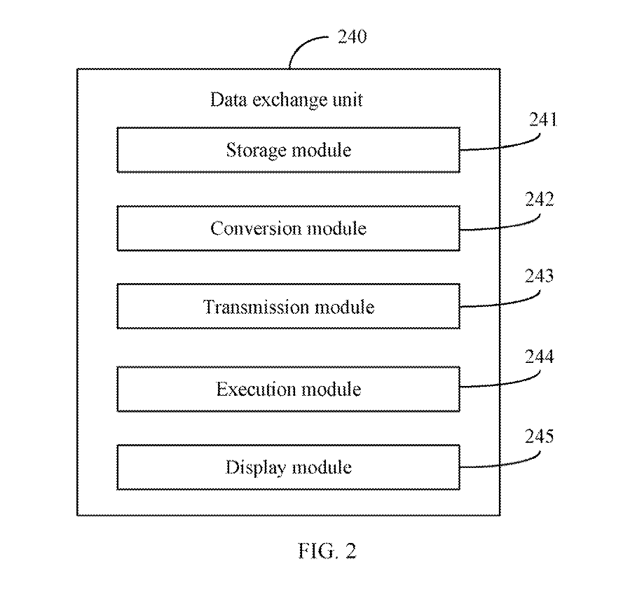

FIG. 2 is a block diagram of one embodiment of a data exchange unit 240. The data exchange unit 240 automatically exchange data between the electronic device 2 and the remote display 3. In one embodiment, the data exchange unit 240 includes a storage module 241, a conversion module 242, a transmission module 243, an execution module 244 and a display module 245. The modules 241-245 may include computerized code in the form of one or more programs that are stored in the storage unit 24. The computerized code includes instructions that are executed by the at least one processor 22 to provide functions for modules 241-245. The storage unit 24 may be a memory, a hard disk drive, or a cache.

The storage module 241 is operable to save the contact coordinates into the buffer storage 32. In one embodiment, the contact coordinates are generated by the touch panel 34 when a finger or stylus touches/contacts the touch panel 34. The storage module 241 sends the contact coordinates to the buffer storage 32 and saves the contact coordinates in the buffer storage 32.

The conversion module 242 is operable to convert the contact coordinates into converted coordinates having a readable format that respectively links to the applications stored in the storage unit 24. The at least one processor 22 can execute the applications according to the converted coordinates having the readable format.

In addition, the conversion module 242 converts the images corresponding to the applications into converted images in an executable format of the remote display 3. For example, the executable format of the remote display 3 can be JPEG, BMP, or GIF format.

The transmission module 243 is operable to transmit the converted coordinates from the second wireless communication module 30 through the first wireless communication module 20 to the at least one processor 22. In addition, the transmission module 243 further transmits the images corresponding to the applications from the storage unit 24 to the buffer storage 32 through the first wireless communication module 20 and the second wireless communication module 30.

The execution module 244 is operable to execute the applications corresponding to the converted coordinates. In one embodiment, one converted coordinate links to the media player for playback of video files in the user interface of the electronic device 1. If the data exchange unit 240 detects one of the one coordinates linking to the media player in the user interface, the execution module 244 enables the at least one processor 22 to execute the media player to play the video files.

The display module 245 is operable to display the images corresponding to the applications on the remote display 3.

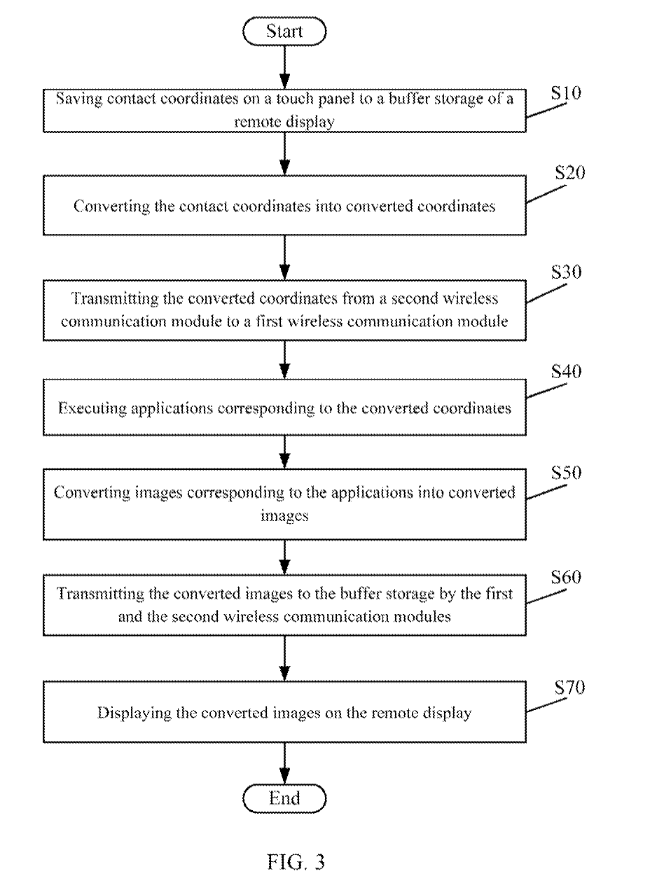

FIG. 3 is a flowchart of one embodiment of a method for data exchange using an electronic device 2 and the remote display 3. Depending on the embodiment, additional blocks may be added, others deleted, and the ordering of the blocks may be changed.

In block S10, the storage module 241 saves contact coordinates from the touch panel 34 into the buffer storage 32 of the remote display 3. As mentioned above, the contact coordinates are generated by contacting the touch panel 34 when a finger or stylus touches/contacts the touch panel 34. For example, the user uses the finger to contact the touch panel 34 and the contact points are related to the contact coordinates.

In block S20, the conversion module 242 converts the contact coordinates into converted coordinates having a readable format of the at least one processor 22. For example, if a contact coordinate is (2, 3), the conversion module 242 converts the (2, 3) into a converted coordinate having a readable format (e.g., a hexadecimal format), the at least one processor 22 can read the converted coordinate having the hexadecimal format. In one embodiment, the converted coordinates respectively links to the applications stored in the storage unit 24. The at least one processor 22 can execute the applications according to the converted coordinates having the readable format.

In block S30, the transmission module 243 transmits the converted coordinates from the second wireless communication module 30 of the remote display 3 through the first wireless communication module 20 of the electronic device 2 to the at least one processor 22.

In block S40, the execution module 244 enables the at least one processor 22 to execute the applications corresponding to the converted coordinates.

In block S50, the conversion module 242 converts images corresponding to the applications into converted images in an executable format of the remote display unit 3.

In block S60, the transmission module 243 transmits the converted images to the buffer storage 32 by the first wireless communication module 20 and the second wireless communication module 30.

In block S70, the display module 245 displays the converted images on the touch panel 34 of the remote display 3.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage unit;
at least one processor; and
one or more programs stored in the storage unit and being executable by the at least one processor, the one or more programs comprising:
a storage module operable to save contact coordinates on a touch panel of a remote display to a buffer storage of the remote display, the contact coordinates corresponding to a touch of the touch panel;
a transmission module operable to transmit the contact coordinates from a second wireless communication module of the remote display to a first wireless communication module of the electronic device;
an execution module operable to execute applications installed in the electronic device corresponding to the contact coordinates;
the transmission module further operable to transmit images corresponding to the applications to the buffer storage by the first and the second wireless communication modules; and
a display module operable to display the images corresponding to the applications on the remote display.

2. The data exchange system of claim 1, wherein the touch panel of the remote display is a capacitive panel.

3. The data exchange system of claim 1, wherein the touch panel of the remote display is a resistive panel.

4. The data exchange system of claim 1, wherein the first and the second wireless communication modules are BLUETOOTH modules or infrared modules.

5. The data exchange system of claim 1, wherein the electronic device is selected from the group consisting of a mobile phone, a tablet computer, a personal digital assistant or a handheld game console.

6. A method for data exchange using an electronic device and a remote display, the method comprising:
saving contact coordinates on a touch panel of the remote display to a buffer storage of the remote display, the contact coordinates corresponding to a touch of the touch panel;
transmitting the contact coordinates from a second wireless communication module of the remote display to a first wireless communication module of the electronic device;
executing applications installed in the electronic device corresponding to the contact coordinates;
transmitting images corresponding to the applications to the buffer storage by the first and the second wireless communication modules; and
displaying the images corresponding to the applications on the remote display.

7. The method of claim 6, wherein the step of displaying the converted images is by a capacitive panel.

8. The method of claim 6, wherein the step of displaying the converted images is by a resistive panel.

9. The method of claim 6, wherein the first and the second wireless communication modules are BLUETOOTH modules or infrared modules.

10. The method of claim 6, wherein the electronic device is selected from the group consisting of a mobile phone, a tablet computer, a personal digital assistant and a handheld game console.

11. A non-transitory computer-readable medium having stored thereon instructions that, when executed by an electronic device and a remote display, causing the electronic device to perform a method for data exchange, the method comprising:
saving contact coordinates on a touch panel of the remote display to a buffer storage of the remote display, the contact coordinates corresponding to a touch of the touch panel;
transmitting the contact coordinates from a second wireless communication module of the remote display to a first wireless communication module of the electronic device;
executing applications installed in the electronic device corresponding to the contact coordinates;
transmitting images corresponding to the applications to the buffer storage by the first and the second wireless communication modules; and
displaying the images corresponding to the applications on the remote display.

12. The medium of claim 11, wherein the step of displaying the converted images is by a capacitive panel.

13. The medium of claim 11, wherein the step of displaying the converted images is by a resistive panel.

14. The medium of claim 11, wherein the first and the second wireless communication modules are BLUETOOTH modules or infrared modules.

15. The medium of claim 11, wherein the electronic device is selected from the group consisting of a mobile phone, a tablet computer, a personal digital assistant and a handheld game console.
